(19) United States
(12) Patent Application Publication
(10) Pub. No.: US 2025/0351157 A1
(43) Pub. Date: Nov. 13, 2025

(54) INDICATING RADIO RESOURCES OF SIDELINK TRANSMISSION

(71) Applicant: Nokia Technologies Oy, Espoo (FI)

(72) Inventors: Stepan KUCERA, Munich (DE); Berthold PANZNER, Holzkirchen (DE); Taylan SAHIN, Munich (DE); Diomidis MICHALOPOULOS, Munich (DE); Prajwal KESHAVAMURTHY, Munich (DE)

(21) Appl. No.: 18/854,431

(22) PCT Filed: Apr. 7, 2022
(86) PCT No.: PCT/EP2022/059294

§ 371 Date: Oct. 4, 2024

(51) Int. Cl. H04W 72/25; H04W 72/044

(52) U.S. Cl. CPC H04W 72/25; H04W 72/044

(57) ABSTRACT

Disclosed is a method comprising transmitting information indicating radio resources of a sidelink transmission divided into a plurality of first segments in a plurality of time slots, wherein the plurality of first segments partially overlap in frequency domain, and wherein the plurality of first segments are inter-connected in time domain by at least one second segment comprising one or more radio resources for combining the plurality of first segments.

### FIELD

The following example embodiments relate to wireless communication.

### BACKGROUND

In wireless communication, different transmissions may collide and degrade each other, if they occur on the same time and frequency resources. It is desirable to avoid such collisions.

### BRIEF DESCRIPTION

The scope of protection sought for various example embodiments is set out by the claims. The example embodiments and features, if any, described in this specification that do not fall under the scope of the claims are to be interpreted as examples useful for understanding various embodiments.

According to an aspect, there is provided an apparatus comprising at least one processor, and at least one memory including computer program code, wherein the at least one memory and the computer program code are configured, with the at least one processor, to cause the apparatus to: transmit information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments.

According to another aspect, there is provided an apparatus comprising means for: transmitting information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments.

According to another aspect, there is provided a method comprising: transmitting information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments.

According to another aspect, there is provided a computer program comprising instructions which, when executed by an apparatus, cause the apparatus to perform at least the following: transmitting information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments.

According to another aspect, there is provided a computer program comprising instructions for causing an apparatus to perform at least the following: transmitting information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments.

According to another aspect, there is provided a computer readable medium comprising program instructions for causing an apparatus to perform at least the following: transmitting information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments.

According to another aspect, there is provided a non-transitory computer readable medium comprising program instructions for causing an apparatus to perform at least the following: transmitting information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments.

According to another aspect, there is provided a system comprising at least a first user device and a second user device. The first user device is configured to transmit information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments. The second user device is configured to receive the information.

According to another aspect, there is provided a system comprising at least a first user device and a second user device. The first user device comprises means for transmitting information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments. The second user device comprises means for receiving the information.

### LIST OF DRAWINGS

In the following, various example embodiments will be described in greater detail with reference to the accompanying drawings, in which

FIG. 1 illustrates an example embodiment of a cellular communication network;

FIG. 2 illustrates new radio sidelink mode 1;

FIG. 3 illustrates an example, where a wideband sidelink positioning reference signal transmission collides with a sidelink data transmission;

FIG. 4a illustrates an example, where a wideband sidelink positioning reference signal transmission collides with a sidelink data transmission;

FIGS. 4b and 4c illustrate examples, where the collision is avoided by dividing the sidelink positioning reference signal transmission into two segments;

FIG. 5 illustrates a flow chart according to an example embodiment;

FIG. 6 illustrates a signaling diagram according to an example embodiment;

FIG. 7 illustrates a signaling diagram according to an example embodiment;

FIGS. 8a and 8b illustrate some example shapes of sidelink positioning reference signal segments;

FIGS. 9a-9e illustrate example schedules of a bridge between two sidelink positioning reference signal segments;

FIG. 10 illustrates a signaling diagram according to an example embodiment;

FIG. 11 illustrates a signaling diagram according to an example embodiment;

FIG. 12 illustrates an example of adding additional radio resources to a bridge based on feedback information from a receiver;

FIG. 13 illustrates an example of transmitting updated sidelink control information;

FIG. 14 illustrates an example of blanking post-collision resources of a bridge; and

FIG. 15 illustrates an example embodiment of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

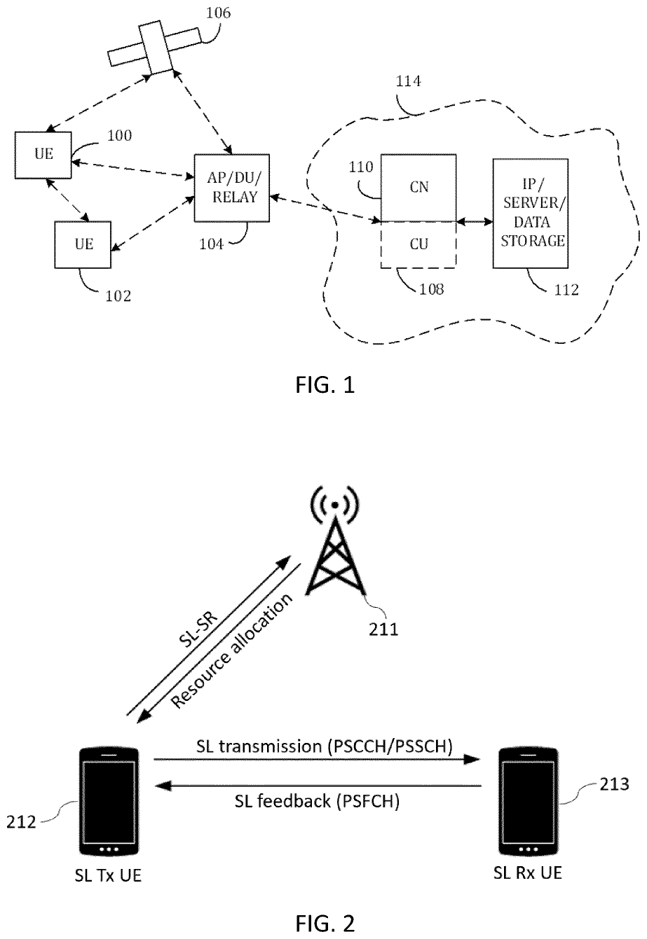

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the system, the counterpart on the CN side may be a serving gateway (S-GW, routing and forwarding user data packets), packet data network gateway (P-GW) for providing connectivity of user devices to external packet data networks, user plane function (UPF), mobility management entity (MME), access and mobility management function (AMF), or location management function (LMF), etc.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud. The user device (or in some example embodiments a layer 3 relay node) may be configured to perform one or more of user equipment functionalities. The user device may also comprise, or be comprised in, a robot or a vehicle such as a train or a car.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It may also be possible that node operations are distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have an access to a plurality of radio cells and the system may also comprise other apparatuses, such as physical layer relay nodes or other network elements, etc. At least one of the access nodes may be a Home eNodeB or a Home gNodeB.

Furthermore, the access node may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the access node. The DU may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned access node units, or different core network operations and access node operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto-or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

Positioning techniques may be used to estimate a physical location of a device such as a UE. For example, the following positioning techniques may be used in NR: downlink time difference of arrival (DL-TDoA), uplink time difference of arrival (UL-TDoA), downlink angle of departure (DL-AoD), uplink angle of arrival (UL-AoA), and multi-cell round trip time (multi-RTT).

Positioning solutions can be categorized by the entity performing the positioning estimation. Network-based positioning refers to solutions, where the UE position is calculated by a network element. For this network-based positioning, the UE may report the necessary information to the network for the calculation. UE-based positioning refers to solutions, where the UE position is calculated by the UE.

The positioning reference signal (PRS) and/or sounding reference signal (SRS) may be used as reference signals for estimating the location of the UE. PRS is a reference signal for positioning in the downlink (DL). SRS is a reference signal that may be used for positioning in the uplink (UL). It should be noted that SRS may also be used for other purposes than positioning. In an NR system, there may be two types of SRS and those SRS may be separately configured to a UE from a gNB. One is SRS for MIMO introduced in NR Rel-15 and another one is SRS for positioning purpose, which has been introduced in NR Rel-16. SRS for MIMO can also be used for positioning.

In sidelink positioning, a target UE may be positioned based on one or more sidelink positioning reference signals (SL PRS) transmitted from the target UE to one or more anchor UEs, and/or based on one or more SL PRSs received by the target UE from the one or more anchor UEs. Herein the term “anchor” may refer to a positioning anchor. The target UE refers to a UE to be localized (positioned). Sidelink positioning may be used in many different use cases, such as (but not limited to) public safety applications, vehicular applications, and/or industrial applications.

The positioning of the target UE may refer to estimating an absolute or relative position of the UE. The absolute position is an estimate of the target UE position in two-dimensional or three-dimensional geographic coordinates (e.g., latitude, longitude, elevation) within a coordinate system. The relative position is an estimate of the target UE position relative to other network elements or to other UEs.

For example, the following three network coverage scenarios may be considered, when at least two UEs are involved in positioning. Taking two UEs as an example, an in-coverage scenario refers to the case, where both UEs are inside the network coverage. Partial coverage means that one UE remains inside the network coverage, but the other UE is outside the network coverage. Out-of-coverage scenario refers to the case, where both UEs are outside the network coverage. A given UE may transit between in-coverage, partial coverage and out-of-coverage scenarios. There may be some use cases that require positioning, when there is no network and no global navigation satellite system (GNSS) coverage.

NR sidelink (SL) enables a UE to communicate directly with one or more other nearby UEs via sidelink communication. Two resource allocation modes have been specified for SL, and an SL transmitter (Tx) UE may be configured with one of them to perform its sidelink transmission(s). These modes are denoted as NR SL mode 1 and NR SL mode 2.

FIG. 2 illustrates NR SL mode 1. In NR SL mode 1, SL transmission resources are assigned by a gNB 211 to an SL Tx UE 212. The SL Tx UE 212 transmits a sidelink scheduling request (SL-SR) to the gNB 211. The gNB 211 indicates the SL resource allocation for the SL Tx UE 212 in response to receiving the SL-SR. Upon receiving the SL resource allocation, the SL Tx UE 212 transmits an SL transmission to an SL receiver (Rx) UE 213 based on the SL resource allocation via a physical sidelink control channel (PSCCH) or a physical sidelink shared channel (PSSCH). In response to the SL transmission, the SL Rx UE 213 transmits an SL feedback transmission to the SL Tx UE 212 via a physical sidelink feedback channel (PSFCH).

In NR SL mode 2, an SL Tx UE autonomously selects its SL transmission resources with the aid of a sensing procedure. More specifically, the SL Tx UE in NR SL mode 2 first performs a sensing procedure over the configured SL transmission resource pool(s) during a sensing time window, in order to obtain knowledge of the resource(s) reserved by other nearby SL Tx UE(s). Based on the knowledge obtained from the sensing, the SL Tx UE may select resource(s) from the available SL resources accordingly during a selection time window. Resources deemed as available for selection for the next time period may still need to have a listen-before-talk (LBT) check prior to access.

In order for an SL UE to perform sensing and obtain the necessary information to receive a SL transmission, it may need to decode the sidelink control information (SCI). The SCI may comprise a 1st stage SCI and a 2nd stage SCI. The 1st stage SCI may be carried on PSCCH, and may comprise information indicating radio resources (e.g., time and frequency resources) being utilized or reserved. The 2nd stage SCI may be carried on PSSCH, and may comprise, for example, sidelink hybrid automatic repeat request (HARQ) feedback between sidelink UEs.

SL data transmissions may be accommodated in any time-frequency resources of the resource pool that is (pre-) configured for SL transmissions. These transmissions may have limited bandwidth of just several subchannels, but their overall density in the resource pool can be arbitrary. Herein subchannels are referred to as a scheduling unit in frequency domain for SL, but any other unit such as subcarrier or resource block may alternatively be used as a scheduling unit in frequency domain.

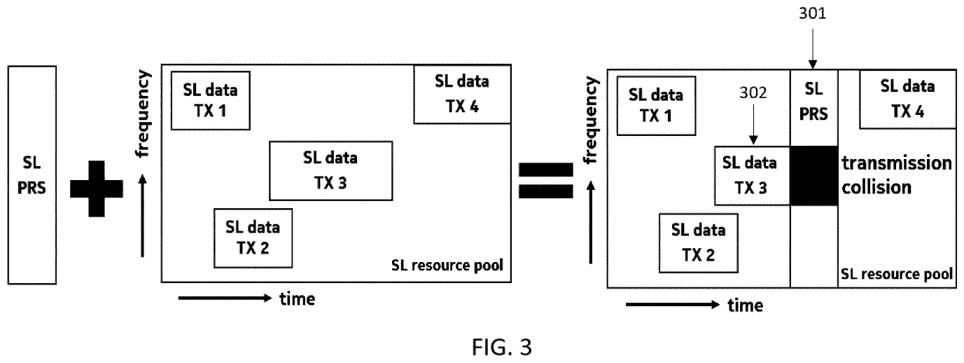

Thus, there is a challenge in how to accommodate sidelink positioning reference signals used for NR positioning in the SL resource pools (see FIG. 3), which may require relatively large bandwidth due to high accuracy requirements (e.g., as known from the Cramér-Rao bound for positioning processes). Although UL/DL PRS is a wideband signal that spans contiguously over potentially very large bandwidths (e.g., the entire usable bandwidth), such wideband transmission of PRS in SL may be challenging. Even under low SL data traffic, there may be a collision between the wideband SL PRS and SL data transmissions, which would negatively impair both positioning and data transfer. This is because the foreseen bandwidth for SL transmissions may be insufficient to meet the high accuracy requirements for SL PRS.

FIG. 3 illustrates an example, where a wideband SL PRS transmission 301 collides with a randomly distributed SL data transmission 302, causing degradation or failure of the positioning and data transfer procedures.

Therefore, accommodating both SL data and SL PRS transmissions without any collisions in the same SL resource pool that has a limited bandwidth calls for efficient and dynamic mechanisms in terms of resource allocation.

Some example embodiments may provide a dynamic, flexible and lightweight mechanism for transmitting a sidelink transmission such as SL PRS and permitting for simultaneous transmission of both SL PRS and another parallel transmission, such as a data transmission.

Some example embodiments are described below using principles and terminology of 5G technology without limiting the example embodiments to 5G communication systems, however.

Some example embodiments may use a modular approach to SL PRS design, wherein a plurality of SL PRS segments are transmitted in multiple different time slots and selected frequency sub-bands such that any conflict of these segments with other transmissions is avoided or at least controlled. These segments are inter-connected by using time-domain channel-tracking “bridges”, for which any collisions with other parallel transmissions are also avoided or at least controlled. Herein a bridge may also be referred to as a resource for maintaining the phase continuity between the SL PRS segments. The idea of the bridge is to provide samples for phase alignment for combining the SL PRS segments. In the context of this modular SL PRS design (i.e., SL PRS divided into multiple segments), some example embodiments may provide a flexible signaling framework that enables co-existence of SL PRS segments with other parallel transmission(s).

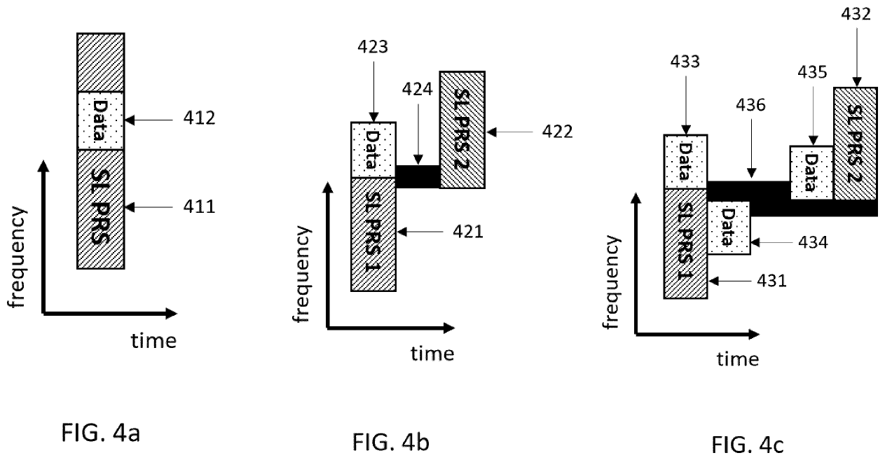

An SL PRS transmission, which may occupy a single time slot and the entire frequency band, may avoid one or more collisions with other parallel transmission(s), if the monolithic SL PRS is divided into multiple time slots and orthogonal frequency sub-bands that are selected to avoid any collisions with the other transmission(s). A condition for such a modular multi-segment SL PRS transmission may be, however, that all frequency-domain SL PRS segments are inter-connected with contiguous time-domain “bridges” (see FIGS. 4b and 4c) to permit for a subsequent reconstruction of the wideband SL PRS from its multiple segments. This can be done, for example, by using soft combining based on phase tracking.

FIG. 4a illustrates an example, where there is a collision of a wideband SL PRS 411 and a data transmission 412. In other words, the data transmission 412 overlaps with the SL PRS 411 in time and frequency domain.

In FIGS. 4b and 4c, to avoid collision between the SL PRS and data transmission, the wideband SL PRS transmission is divided into a plurality of SL PRS segments transmitted at different times, but partially overlapping in frequency domain. The addition of so-called “bridges” 424, 436 between the SL PRS segments ensures time-domain PRS continuity for channel tracking and PRS recombining purposes.

FIG. 4b illustrates an example, where the collision is avoided by dividing the SL PRS into two segments 421, 422, wherein the second SL PRS segment 422 is transmitted at a different time compared to the first SL PRS segment 421 and the data transmission 423. These two SL PRS segments 421, 422 are inter-connected in time domain by a bridge segment 424 for continuous time-domain channel tracking between the two SL PRS segments 421, 422. In other words, the bridge segment 424 comprises one or more radio resources for combining the two SL PRS segments 421, 422.

FIG. 4c illustrates an example with a more complex bridge segment 436 for avoiding collision with multiple data transmissions 433, 434, 435, while preserving channel tracking continuity between two SL PRS segments 431, 432. The complex bridge segment 436 includes one or more bridge segments in order to preserve the channel tracking continuity.

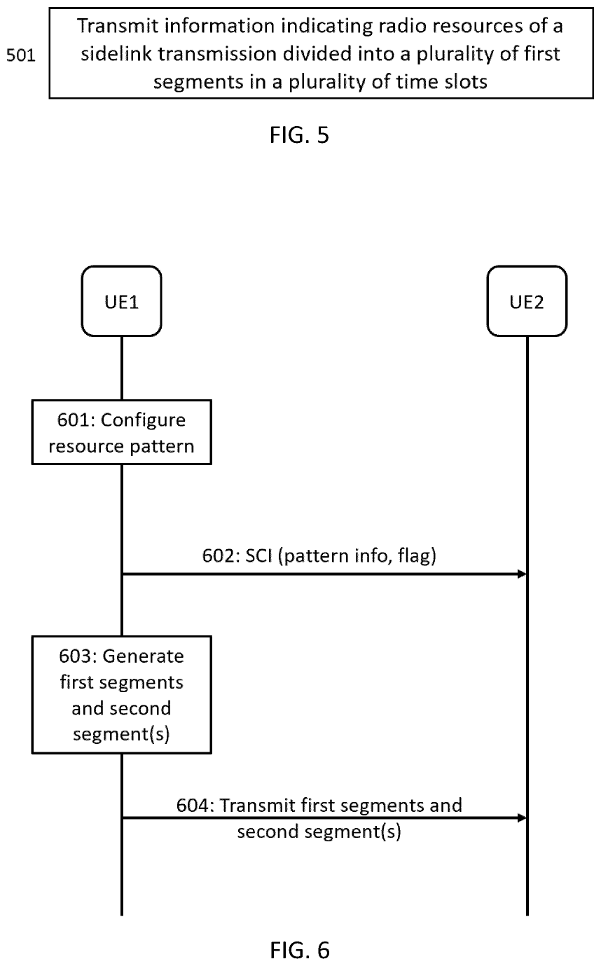

FIG. 5 illustrates a flow chart according to an example embodiment of a method performed by an apparatus such as, or comprising, or comprised in, a user device. The user device may also be called a subscriber unit, mobile station, remote terminal, access terminal, user terminal, terminal device, user equipment (UE), or SL Tx UE. The user device may correspond to one of the user devices 100, 102 of FIG. 1.

Referring to FIG. 5, in block 501, the apparatus may be configured to transmit information, for example sidelink control information, indicating radio resources of a sidelink transmission divided into a plurality of first segments in a plurality of time slots, wherein the plurality of first segments partially overlap in frequency domain. The plurality of first segments are inter-connected in time domain by at least one second segment comprising one or more radio resources for combining the plurality of first segments. At least a part of the at least one second segment may overlap with the plurality of first segments in frequency domain.

The sidelink transmission may comprise, for example, a sidelink positioning reference signal, in which case the plurality of first segments may be SL PRS segments (e.g., as shown in FIGS. 4b and 4c). Alternatively, the sidelink transmission may comprise, for example, a radar-like transmission for environment sensing purposes, or another transmission requiring phase-tracking over time domain.

Herein the at least one second segment may refer to a bridge segment (e.g., 424 or 436 as shown in FIGS. 4b and 4c). The one or more radio resources comprised in the at least one second segment may also be referred to as channel tracking resources, phase alignment resources, or recombination resources.

In some example embodiments, mutual collisions and/or interference may be avoided (or permitted but controlled) by using one or more indications, such as dynamic SCI flags, depending on the network needs. For example, SCI flags may be used to ensure (e.g., by gNB in NR SL Mode 1 or the SL TX UE in NR SL Mode 2) that other parallel transmissions do not collide with the time-domain inter-connecting bridge(s), but may collide with frequency-domain SL PRS segments for example subject to a minimum signal-to-interference-plus-noise ratio (SINR) limit to enable better delivery of data. For example, SL PRS may be muted in radio resources used by a higher-priority data transmission, such as an ultra-reliable low-latency communication (URLLC) transmission, to enable the higher-priority data transmission without degrading the SL PRS segment.

FIG. 6 illustrates a signaling diagram according to an example embodiment for NR SL mode 2, wherein the resource pattern is configured by an SL Tx UE.

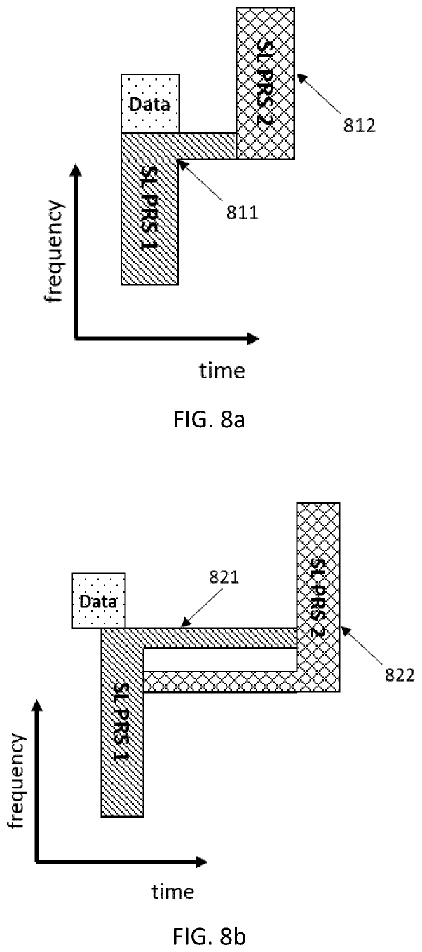

Referring to FIG. 6, in step 601, a first user device (SL Tx UE) schedules a sidelink transmission for avoiding collision with one or more other transmissions by dividing the sidelink transmission into a plurality of first segments in a plurality of time slots, wherein at least two of the plurality of first segments partially overlap each other in the frequency domain. The plurality of first segments are inter-connected in time domain by at least one second segment comprising one or more radio resources for combining the plurality of first segments. The first user device may configure a resource pattern indicating an allocation of radio resources in time and frequency domain for the plurality of first segments and for the at least one second segment with respect to a certain shape such as of letters I, L, F, H, C, etc. Some examples of these shapes are presented in FIGS. 8a and 8b. The resource pattern may be a pre-defined resource pattern, for example from a standardized list such as a codebook.

The sidelink transmission may comprise, for example, a sidelink positioning reference signal, in which case the plurality of first segments may be SL PRS segments. Alternatively, the sidelink transmission may comprise, for example, a radar-like transmission for environment sensing purposes, or another transmission requiring phase-tracking over time domain.

Herein the at least one second segment may refer to a bridge segment as described above. The one or more radio resources comprised in the at least one second segment may also be referred to as channel tracking resources, phase alignment resources, or recombination resources.

The plurality of first segments may be scheduled based on at least one of: a minimum number of first segments, a maximum number of first segments, a minimum number of radio resources per first segment, and/or a maximum number of radio resources per first segment.

The at least one second segment may be scheduled based on at least one of: a minimum number of second segments, a maximum number of second segments, a minimum length per second segment in time domain, a maximum length per second segment in time domain, a minimum width per second segment in frequency domain, and/or a maximum width per second segment in frequency domain.

The minimum and/or maximum width per second segment may be relative to a separation of the plurality of first segments in time domain. For example, the longer the time-domain separation of first segments (e.g., SL PRS 1 and SL PRS 2 in FIGS. 8a and 8b), the higher may be the number of horizontal second segments (bridges), and/or the more frequency resources may be allocated to such bridges. The idea is to ensure higher likelihood of successful channel tracking under collisions, interference, and other adverse phenomena. By limiting the number of bridges and/or resources allocated to such bridges, it may be possible to effectively control the time-domain distance between the vertical first segments, and vice versa.

The above values or ranges may be configured by the network or determined autonomously by the first user device for example as a function of the sidelink channel busy ratio (CBR), mobility, etc.

In step 602, prior to transmitting the sidelink transmission, the first user device transmits sidelink control information to a second user device (SL Rx UE). The sidelink control information indicates the radio resources of the sidelink transmission based on the configured resource pattern or indicates the resource pattern index based on the codebook.

The sidelink control information may further comprise one or more indications, such as SCI flags, for controlling usage of the radio resources comprised in the plurality of first segments and/or the at least one second segment at least at the second user device.

For example, the one or more indications may comprise an indication, denoted as a C flag (“collisions permitted” or “collisions not permitted”), indicating whether other transmissions are permitted to collide with the plurality of first segments and/or the at least one second segment. For example, the C flag may be a bit, and a value (0 or 1) of this bit may indicate whether other transmitters are permitted to reuse the radio resources of the plurality of first segments and/or the at least one second segment for other transmissions. The other transmissions may comprise higher-priority transmissions, such as URLLC transmissions.

The one or more indications may further indicate one or more requirements, such as certain quality of service (QoS) requirements, to be fulfilled for permitting collisions with the plurality of first segments and/or the at least one second segment. For example, the one or more requirements may comprise at least a range for a signal power related metric to be fulfilled at the second user device. The signal power related metric may comprise, for example, received power, interference, signal-to-noise ratio, or SINR. For example, collisions between the plurality of first segments and other transmissions may be permitted, if a minimum SINR is preserved at the second user device.

As another example, the one or more indications may comprise an indication, denoted as a P flag (“puncturing enabled” or “puncturing not enabled”), indicating whether at least a subset of the radio resources comprised in the plurality of first segments are punctured. For example, the P flag may be a bit, and a value (0 or 1) of this bit may indicate whether the transmitted plurality of first segments will be muted (i.e., punctured) in those radio resources that will be used by other parallel (e.g., URLLC) transmissions.

For example, the first user device may puncture at least the subset of the radio resources in the plurality of first segments in response to detecting that at least the subset of the radio resources is allocated to one or more other transmissions (e.g., higher-priority transmissions such as URLLC). Thus, the first user device may mute these resources in case it detects that these resources have already been allocated for example to a data transmission, in order to prevent interference to the data receiver. For example, the first user device may transmit the entire first segment but mute the subset of radio resources that would jam the data transmission.

As another example, the one or more indications may comprise an indication, denoted as a B flag (“blanking enabled” or “blanking not enabled”), indicating whether at least a subset of the one or more radio resources comprised in the at least one second segment are punctured (i.e., muted). For example, the B flag may be a bit, and a value (0 or 1) of this bit may indicate whether the sidelink transmission will mute at least the subset of the one or more radio resources that are not usable for channel tracking (e.g., after a collision). Herein the blanking may mean that not only the colliding resources in a given second segment are muted, but also the subsequent resources (in time domain) following the colliding resources in that second segment, since these resources lost usability for any phase tracking, and so continuing the bridge transmission in them would serve no purpose.

For example, the first user device may puncture the subset of the one or more radio resources and the subsequent radio resources in the at least one second segment in response to detecting a collision with the subset of the one or more radio resources. In other words, the resource(s) of a bridge segment may be released after an unexpected collision with a parallel data transmission occurred and the bridge segment became useless for channel tracking purposes.

The one or more indications in the sidelink control information may comprise at least one of the C flag, the P flag, and/or the B flag.

In step 603, the first user device generates the plurality of first segments and the at least one second segment based on the configured resource pattern.

In step 604, the first user device transmits the plurality of first segments and the at least one second segment to the second user device. The second user device may then combine the plurality of first segments over the at least one second segment to reconstruct the full sidelink transmission.

The receiver of the sidelink transmission may also need to know what to expect. That is, when the first user device divides the sidelink transmission into the plurality of first segments in the plurality of time slots and transmits one of the first segments at a later time slot, the first user device may notify the second user device (i.e., the receiver) about when to expect this “delayed” first segment. In other words, the first user device may transmit, to the second user device, an indication related to time information indicating one or more time slots of the plurality of time slots comprising the plurality of first segments. Otherwise, the receiver may not know that the delayed first segment is coming.

To this end, one option is to indicate the time slot(s) in the SL positioning assistance data, which may be provided from the first user device to the second user device before the first user device starts transmitting the plurality of first segments to the second user device.

As another option, the time slot(s) may be indicated as part of the sidelink transmission itself (i.e., in step 604). For example, a PRS sequence may be a pseudo-random quadrature phase shift keying (QPSK) sequence, where a few bits of information can fit into the PRS. This could be used for SL PRS to indicate the missing SL PRS segment (if any), and the A-timeslot (i.e., how many timeslots later) this is expected to follow.

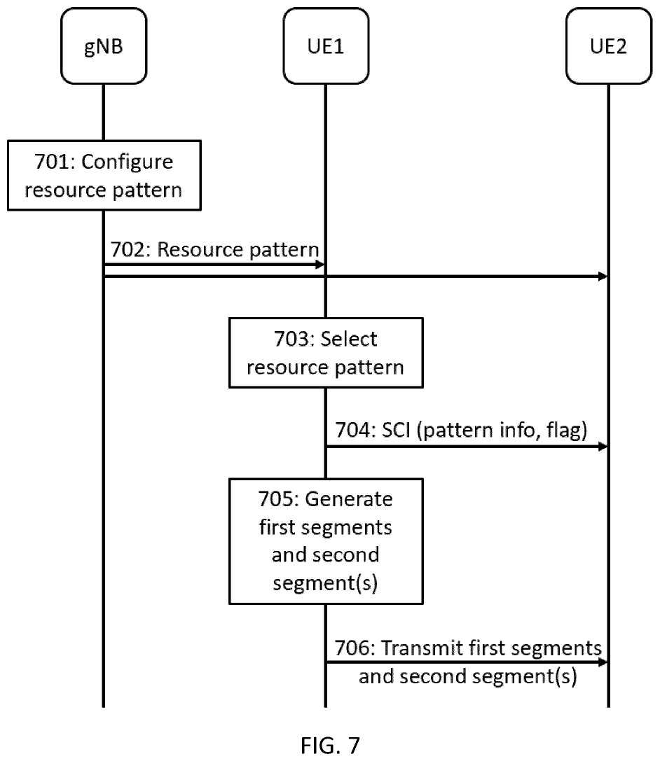

FIG. 7 illustrates a signaling diagram according to an example embodiment for NR SL mode 1, wherein the resource pattern is configured by a network element such as a gNB.

Referring to FIG. 7, in step 701, a network element, such as a gNB, schedules a sidelink transmission for avoiding collision with one or more other transmissions by dividing the sidelink transmission into a plurality of first segments in a plurality of time slots, wherein the plurality of first segments partially overlap in frequency domain. The plurality of first segments are inter-connected in time domain by at least one second segment comprising one or more radio resources for combining the plurality of first segments. For example, at least two of the plurality of the first segments partially overlap each other in the frequency domain and the at least two first segments are inter-connected in the time domain by the at least one second segment. The network element may configure a resource pattern indicating an allocation of radio resources in time and frequency domain for the plurality of first segments and for the at least one second segment with respect to a certain shape such as of letters I, L, F, H, C, etc. Some examples of these shapes are presented in FIGS. 8a and 8b. The resource pattern may be a pre-defined resource pattern, for example from a standardized list such as a codebook. Thus, the network element may transmit information (one or more indexes) related to the pre-configured resource pattern based on the codebook.

The sidelink transmission may comprise, for example, a sidelink positioning reference signal, in which case the plurality of first segments may be SL PRS segments. Alternatively, the sidelink transmission may comprise, for example, a radar-like transmission for environment sensing purposes, or another transmission requiring phase-tracking over time domain.

Herein the at least one second segment may refer to a bridge segment as described above. The one or more radio resources comprised in the at least one second segment may also be referred to as channel tracking resources, phase alignment resources, or recombination resources.

In step 702, the network element indicates the configured resource patterns to a first user device (SL Tx UE). The network element may also indicate the configured resource patterns to a second user device (SL Rx UE). Alternatively, the network element indicates the configured resource patterns to the first user device, and the first user device may forward the configured resource patterns to the second user device.

In step 703, the first user device selects one or more resource patterns configured by the network element.

In step 704, prior to transmitting the sidelink transmission, the first user device transmits sidelink control information to the second user device. The sidelink control information indicates the radio resources of the sidelink transmission based on the selected resource pattern(s).

The sidelink control information may further comprise one or more indications, such as SCI flags, for controlling usage of the radio resources comprised in the plurality of first segments and/or the at least one second segment at least at the second user device. The one or more indications may comprise at least one of the C flag, the P flag, and/or the B flag described above. Alternatively, the SCI flags may be transmitted separately.

In step 705, the first user device generates the plurality of first segments and the at least one second segment based on the selected resource pattern(s).

In step 706, the first user device transmits the plurality of first segments and the at least one second segment to the second user device. The second user device may then combine the plurality of first segments over the at least one second segment to reconstruct the full sidelink transmission.

FIGS. 8a and 8b illustrates examples of bridged SL PRS transmissions in two SL PRS segments for avoiding collision with SL data transmissions. FIG. 8a illustrates an “L”-shaped SL PRS segment 811 and an “I”-shaped SL PRS segment 812. FIG. 8b illustrates two “L”-shaped SL PRS segments 821, 822. The bridge inter-connecting the SL PRS segments serves for channel tracking, which may be used for constructively combining the two segments into a single wideband SL PRS. FIGS. 8a and 8b are examples and there may be more than two SL PRS segments to cover the full frequency domain of the slot.

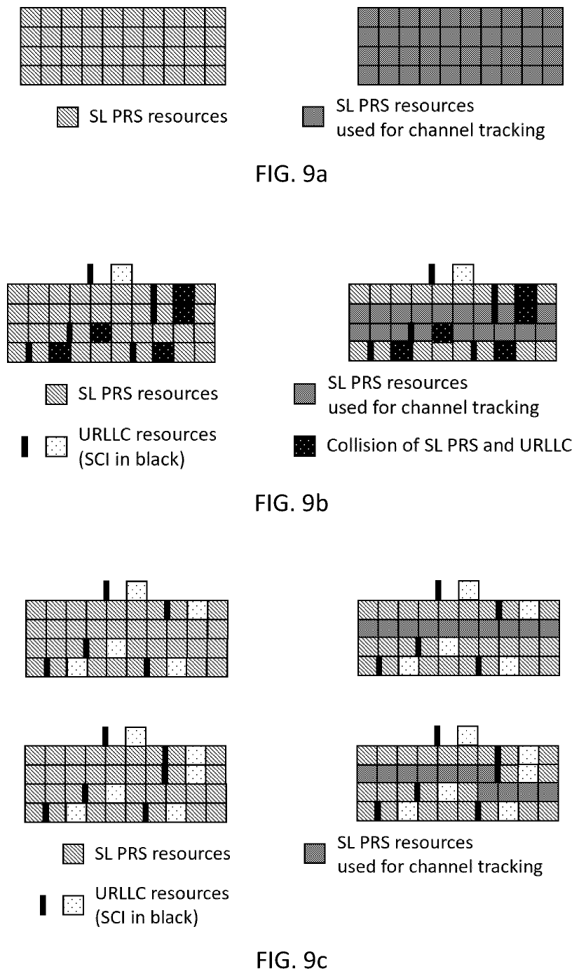

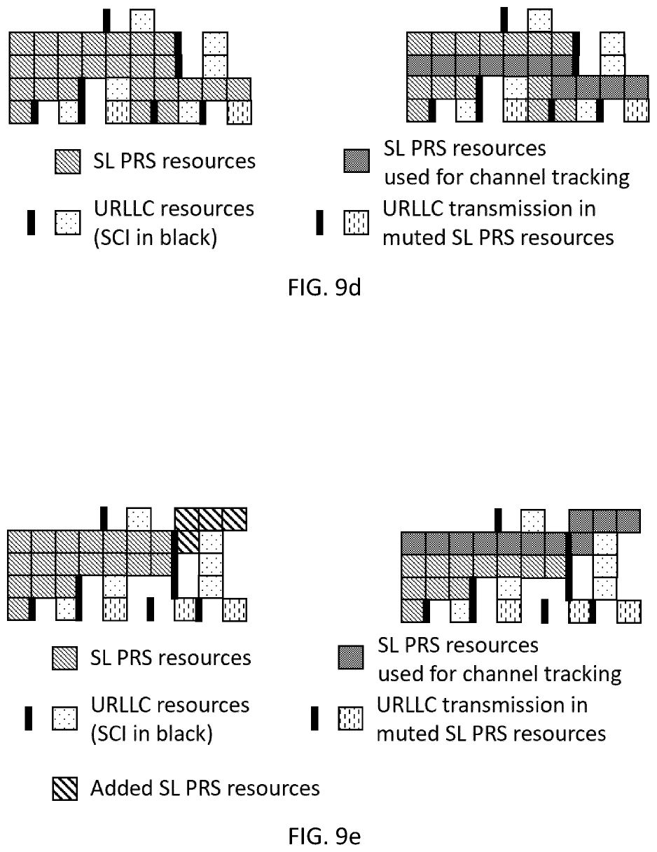

FIGS. 9a-9e present some examples for scheduling bridged SL PRS transmissions based on the interaction options (i.e., SCI flags) described above. FIGS. 9a-9e illustrate examples of a bridge between two SL PRS segments. The SL PRS resources used for channel tracking may provide a bridge for inter-connecting the two SL PRS segments.

FIG. 9a illustrates an example schedule, wherein collisions are not permitted, puncturing is not enabled, and blanking is not enabled (e.g., C=0, P=0, B=0). This schedule forbids any collisions with SL PRS transmissions and offers full protection of both vertical and horizontal segments. Positioning measurements as well as channel tracking for SL PRS segment recombination cannot be interrupted. Any of the SL PRS resources can be used for channel tracking. No collisions may imply maximum SINR.

FIG. 9b illustrates an example schedule, wherein collisions are permitted, puncturing is not enabled, and blanking is not enabled (e.g., C=1, P=0, B=0). In this example, collisions are allowed, but SL PRS resources are not muted in affected areas. Hence, there is mutual interference between SL PRS and URLLC. To ensure high-SINR channel tracking, a wider pool of SL PRS resources is to be used.

FIG. 9c illustrates two example schedules, wherein collisions are permitted, puncturing is enabled, and blanking is not enabled (e.g., C=1, P=1, B=0). Once puncturing is allowed (i.e., SL PRS resources are muted wherever there is a simultaneous URLLC transmission), the interference is mitigated. However, sensing of colliding transmissions (e.g., based on their SCI) may be necessary. Also, channel tracking may be conducted only on time-wise uninterrupted contiguous resources.

FIGS. 9d and 9e illustrate two example schedules, wherein collisions are permitted, puncturing is enabled, and blanking is enabled (e.g., C=1, P=1, B=1). Since the muting of colliding SL PRS resources renders the subsequent time-domain resources not useful for channel tracking due to their discontinuity from preceding resources, these resources can be freed for additional URLLC resources. This process of muting non-colliding SL PRS resources that are not useful for channel tracking is called blanking herein. Muting and blanking resources may, however, cause a substantial reduction of the resources used for channel tracking, possibly to the level where channel tracking becomes impossible and fails (e.g., the last channel tracking path is interrupted by yet another collision). In this case, additional SL PRS resources may need to be added subject to the time-domain contiguity condition.

FIG. 9d illustrates an example of resource blanking, after which channel tracking is still possible.

FIG. 9e illustrates an example of the case, where additional SL PRS resources are added to preserve the channel tracking contiguity.

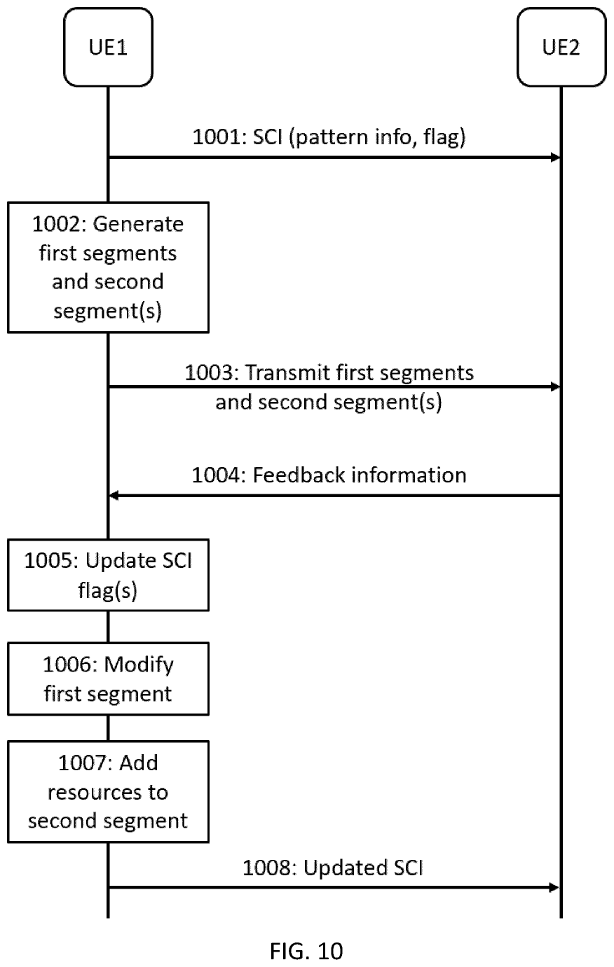

FIG. 10 illustrates a signaling diagram according to an example embodiment, wherein receiver feedback is enabled on individual SL PRS segments. For example, the receiver feedback may be used to announce past or future collisions with other parallel transmission(s). Based on the receiver feedback, the transmitted may dynamically update segment SCI information to permit re-scheduling of SL PRS and/or other transmissions (e.g., to permit or forbid other parallel transmissions in a given SL PRS segment). The transmitter may also dynamically modify or update the schedule of time and frequency domain SL PRS segments, for example by adding, removing, or muting radio resources for individual segments, based on changing SL conditions and/or the receiver feedback.

Referring to FIG. 10, in step 1001, a first user device (SL Tx UE) transmits sidelink control information to a second user device (SL Rx UE). The sidelink control information indicates radio resources of a sidelink transmission divided into a plurality of first segments in a plurality of time slots, wherein the plurality of first segments partially overlap in frequency domain. The plurality of first segments are inter-connected in time domain by at least one second segment comprising one or more radio resources for combining the plurality of first segments.

The sidelink control information may further comprise one or more indications, such as SCI flags, for controlling usage of the radio resources comprised in the plurality of first segments and/or the at least one second segment at the second user device. The one or more indications may comprise at least one of the C flag, the P flag, and/or the B flag described above.

The sidelink transmission may comprise, for example, a sidelink positioning reference signal, in which case the plurality of first segments may be SL PRS segments. Alternatively, the sidelink transmission may comprise, for example, a radar-like transmission for environment sensing purposes, or another transmission requiring phase-tracking over time domain.

Herein the at least one second segment may refer to a bridge segment as described above. The one or more radio resources comprised in the at least one second segment may also be referred to as channel tracking resources, phase alignment resources, or recombination resources.

In step 1002, the first user device generates the plurality of first segments and the at least one second segment based on a pre-defined resource pattern.

In step 1003, the first user device transmits the plurality of first segments and the at least one second segment to the second user device.

In step 1004, the second user device transmits feedback information to the first user device. For example, the second user device (i.e., the intended receiver of the sidelink transmission) may provide feedback information to the first user device (i.e., the transmitter) regarding experienced past collisions and/or expected future collisions with one or more first segments and/or second segments. Alternatively, or additionally, the intended receiver may indicate in the feedback information how successful the time-domain channel tracking was over the bridge (second segment) between two first segments, such as “successful”/“failing”/“failed” status, achievable SINR, and/or a likelihood of channel tracking interruption until the next first segment (e.g., SL PRS segment).

In other words, the feedback information may indicate at least one of: a presence (e.g., a 1-bit ACK-like indication) of one or more experienced past collisions and/or expected future collisions associated with the plurality of first segments, a number or proportion of colliding radio resources (past collisions or expected future collisions) associated with at least one segment of the plurality of first segments (e.g., per segment or segment group), and/or a success or failure of combining the plurality of first segments over the at least one second segment.

In the feedback information, the second user device may also indicate in which particular time and frequency resources there was a collision. Alternatively, the second user device may indicate the available time and frequency resources, which could be used as channel tracking resources for a bridge (second segment). In this way, the second user device and the first user device may coordinate with each other such that the first user device acknowledges that it can provide the additional “bridge” segment. Thus, before any modification of the “bridge” resources, both the transmitter and receiver may be aware (and approve) of such modification.

Alternatively, or additionally, the feedback information may comprise a request for adding additional radio resources and/or an additional segment to the at least one second segment. In other words, the intended receiver may request further resources for a given “bridge” segment, and/or recommend corrective measures, such as: “supplement the bridge with additional tracking resources”, and/or “add a new bridge”.

Alternatively, the feedback information may be transmitted to the network element (e.g., gNB) in case the network element configures the pattern information transmitted at step 1001. When the network element receives the feedback information, the network element may configure or reconfigure the resource pattern information and/or the flag(s). In case the network element modifies or updates the resource pattern information and/or the flag(s), the network element may transmit the updated SCI to the first user device and/or the second user device.

In step 1005, the first user device may update the one or more indications (e.g., the C flag, P flag, and/or B flag) in response to detecting a change in the SL channel conditions associated with the plurality of first segments and/or the at least one second segment for example based on the feedback information. For example, the updated one or more indications may indicate cancelling a permission for collisions (see FIG. 13) with the plurality of first segments in response to detecting an increased amount of collisions with the plurality of first segments.

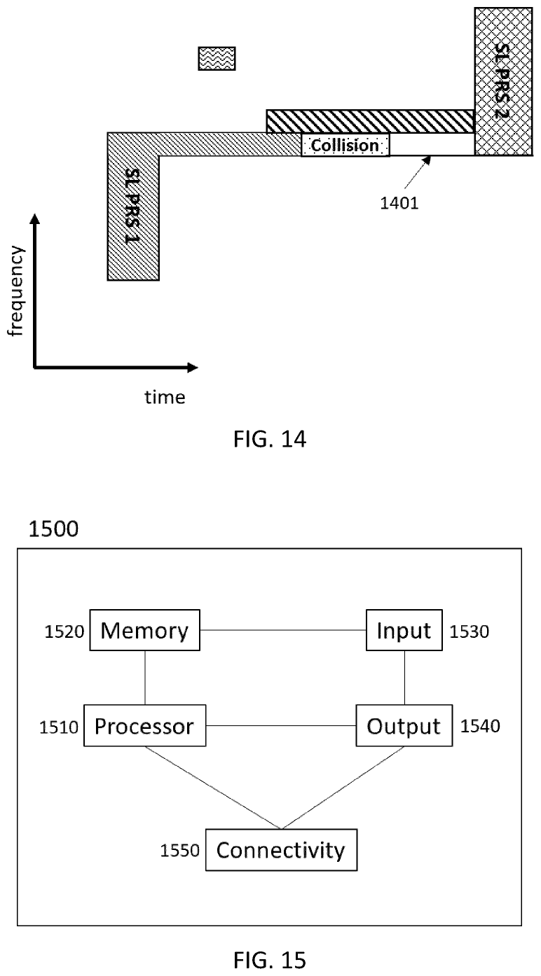

In step 1006, the first user device may modify a segment of the plurality of first segments based on at least one of: one or more past collisions with the segment, and/or an expected future collision with the segment (e.g., as indicated in the feedback information). For example, the modifying may mean that the first user device may dynamically add, remove, or mute radio resources (see FIG. 14) for individual segments to: mitigate the impact of past collisions (e.g., mute the impacted segment entirely or partially), and/or prevent the impact of expected future collisions (e.g., by dividing a colliding SL PRS segment into multiple non-colliding ones or by postponing or shifting the previously scheduled SL PRS segment).

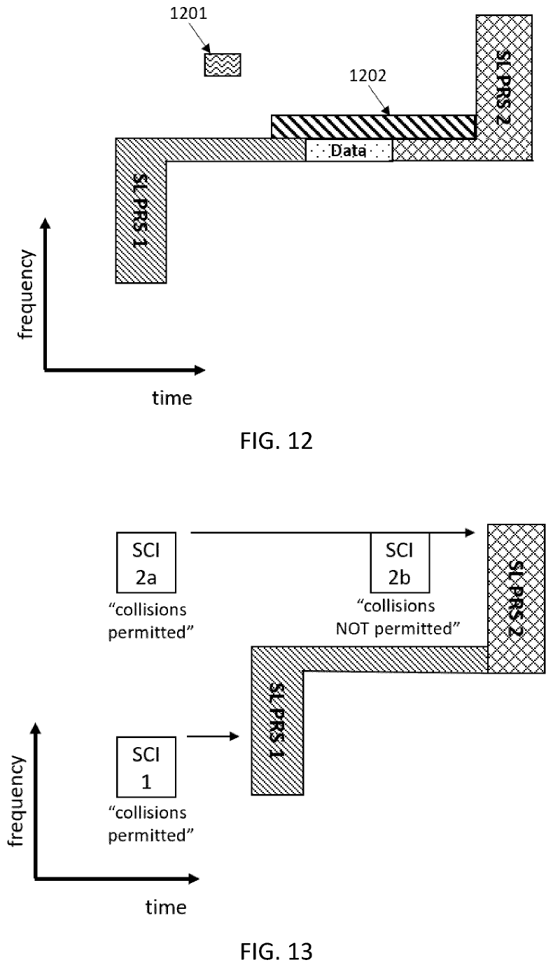

In step 1007, the first user device may add the additional radio resources and/or the additional segment to the at least one second segment (see FIG. 12) based on the request comprised in the feedback information. The first user device may also expand an existing channel-tracking bridge (second segment), if its quality degraded due to past collisions or there is a risk of future collisions (e.g., as seen by the channel busy ratio).

The first user device may also modify resources for an individual bridge (second segment) to accommodate more receivers in the same bridge (second segment). For example, if a new third user device is requesting SL PRS, for which a bridge is needed because of a collision with a data transmission, and if the third user device is within the listening range of the already ongoing SL PRS, then the first user device may minimize the change to the existing SL PRS by modifying the bridge. The new “bridge” may be such that it accommodates both the second user device and the third user device, and this may be indicated to both the second user device and the third user device.

In step 1008, the first user device transmits updated sidelink control information to the second user device. The updated sidelink control information may indicate, for example, at least one of: the updated one or more indications (SCI flags) of step 1005, and/or the modifications made in step 1006 and/or step 1007.

It should be noted that, in case of too many collisions, it may not be possible to find resources to be used as a bridge for a certain amount of time (e.g., the next first segment may come too far in the future, which may not be permitted by latency constraints). In this case, the roles of the transmitter and the receiver may be inverted. The interference may be a problem mainly at the receiver side. When the first user device is the transmitter and the second user device is the receiver, this means that the second user device may see some interference, but the first user device may see less interference. In this scenario, if the roles of the first user device and the second user device are inverted, the “bridge” pattern would be different, since there could be more unoccupied resources close to the first user device than the second user device. Thus, the feedback information may indicate that the second user device proposes to become the transmitter of the sidelink transmission, and the current transmitter (the first user device) to become the receiver. The first user device may then accept the proposal and carry out the switch of the roles.

Alternatively, if the second user device transmits the feedback information to the network element, the network element updates (e.g., reconfigures) the resource pattern and performs step 702, and the first user device performs steps 703 to 706 based on the updated resource pattern.

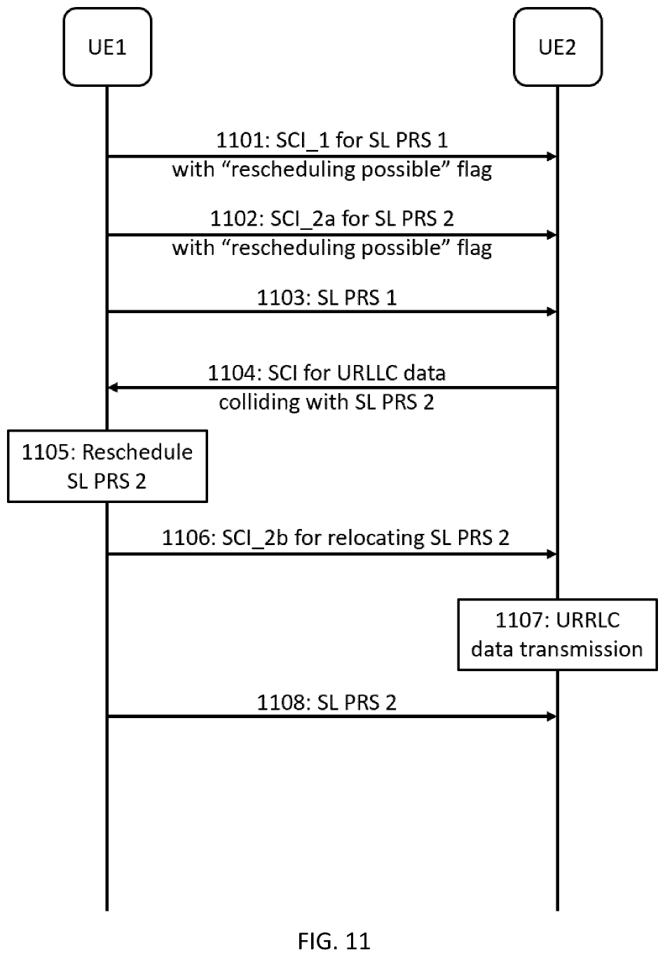

FIG. 11 illustrates a signaling diagram according to an example embodiment, wherein a sidelink transmission (e.g., SL PRS) is divided into two segments denoted as SL PRS 1 and SL PRS 2, and the SL PRS 2 segment is delayed (postponed) to make space for another transmission.

SL PRS 1 and SL PRS 2 may also be referred to as a plurality of first segments herein. SL PRS 1 and SL PRS 2 partially overlap in frequency domain, and they are inter-connected in time domain by at least one second segment comprising one or more radio resources for combining the plurality of first segments.

Referring to FIG. 11, in step 1101, a first user device (SL Tx UE) transmits a first set of sidelink control information (SCI_1) to a second user device (SL Rx UE). SCI_1 indicates radio resources allocated to SL PRS 1, as well as an indication (e.g., flag) indicating that rescheduling of SL PRS 1 is possible, if needed (e.g., for avoiding collision with another transmission).

In step 1102, the first user device transmits a second set of sidelink control information (SCI_2a) to a second user device (SL RX UE). SCI_2a indicates radio resources allocated to SL PRS 2, as well as an indication (e.g., flag) indicating that rescheduling of SL PRS 2 is possible, if needed (e.g., for avoiding collision with another transmission).

In step 1103, the first user device transmits the SL PRS 1 segment to the second user device.

In step 1104, the second user device transmits sidelink control information for another transmission (e.g., for a URLLC data transmission) to the first user device, wherein the sidelink control information indicates that the other transmission will collide with SL PRS 2.

In step 1105, the first user device reschedules the SL PRS 2 segment by delaying (postponing) it in order to avoid the collision with the other transmission.

In step 1106, the first user device transmits an updated second set of sidelink control information (SCI_2b) to the second user device. SCI_2b indicates the radio resources allocated to the rescheduled SL PRS 2 segment.

In step 1107, the second user device transmits the other transmission (e.g., URLLC data transmission).

In step 1108, the first user device transmits the rescheduled SL PRS 2 segment to the second user device.

Since the first user device rescheduled SL PRS 2, there is no collision between SL PRS 2 and the other transmission.

The steps and/or blocks described above by means of FIGS. 5-7 and 10-11 are in no absolute chronological order, and some of them may be performed simultaneously or in an order differing from the described one. Other steps and/or blocks may also be executed between them or within them, and other information may be transmitted and/or received. Some of the steps and/or blocks or a part of the steps and/or blocks may also be left out.

FIG. 12 illustrates an example, where receiver feedback information 1201 indicates an upcoming collision between SL PRS and a data transmission that results into adding additional SL PRS “bridge” resources 1202 to safeguard time-domain continuity of channel tracking between the “SL PRS 1” and “SL PRS 2” segments. The feedback information 1201 may refer to the feedback information transmitted from the second user device to the first user device in step 1004 of FIG. 10. In step 1007 of FIG. 10, the first user device may add additional radio resources to the at least one second segment (bridge) based on the feedback information.

FIG. 13 illustrates an example of re-transmitting updated SCI for the “SL PRS 2” segment. As described above with reference to FIG. 10, a user device transmitting the SL PRS can update the interaction options (SCI flags) dynamically based on the changing SL channel conditions. For example, a permission for collisions can be cancelled after observing an increased amount of collisions on a narrowband bridge. For this purpose, the user device may indicate the update to the schedule via SL control information, for example by employing a 2nd stage SCI for a given 1st stage SCI that indicated the original resource reservation.

In FIG. 13, SCI 2a, which permits collisions between SL PRS 2 and other transmissions, is replaced by a subsequent updated SCI 2b, which forbids any collisions with the SL PRS 2 (e.g., when overall SL PRS SINR becomes too low due to past collisions).

FIG. 14 illustrates an example of blanking post-collision resources 1401 that cannot be efficiently used for channel tracking purposes to minimize overall interference and/or permit new transmissions in the freed-up resources.

FIG. 15 illustrates an example embodiment of an apparatus 1500, which may be an apparatus such as, or comprising, or comprised in, a user device or a network element. The user device may correspond to one of the user devices 100, 102 of FIG. 1. The user device may also be called a subscriber unit, mobile station, remote terminal, access terminal, user terminal, terminal device, or user equipment (UE). The network element may correspond to the access node 104 of FIG. 1. The network element may also be referred to, for example, as a network node, a radio access network (RAN) node, a NodeB, an eNB, a gNB, a base transceiver station (BTS), a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1500 comprises at least one processor 1510. The at least one processor 1510 interprets computer program instructions and processes data. The at least one processor 1510 may comprise one or more programmable processors. The at least one processor 1510 may comprise programmable hardware with embedded firmware and may, alternatively or additionally, comprise one or more application-specific integrated circuits (ASICs).

The at least one processor 1510 is coupled to at least one memory 1520. The at least one processor is configured to read and write data to and from the at least one memory 1520. The at least one memory 1520 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The at least one memory 1520 stores computer readable instructions that are executed by the at least one processor 1510 to perform one or more of the example embodiments described above. For example, non-volatile memory stores the computer readable instructions, and the at least one processor 1510 executes the instructions using volatile memory for temporary storage of data and/or instructions.

The computer readable instructions may have been pre-stored to the at least one memory 1520 or, alternatively or additionally, they may be received, by the apparatus, via an electromagnetic carrier signal and/or may be copied from a physical entity such as a computer program product. Execution of the computer readable instructions causes the apparatus 1500 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. such as RADAR-like transmissions for environment sensing purposes, or transmissions requiring phase tracking over time domain.

The apparatus 1500 may further comprise, or be connected to, an input unit 1530. The input unit 1530 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1530 may comprise an interface to which external devices may connect to.

The apparatus 1500 may also comprise an output unit 1540. The output unit may comprise or be connected to one or more displays capable of rendering visual content, such as a light emitting diode (LED) display, a liquid crystal display (LCD) and/or a liquid crystal on silicon (LCOS) display. The output unit 1540 may further comprise one or more audio outputs. The one or more audio outputs may be for example loudspeakers.

The apparatus 1500 further comprises a connectivity unit 1550. The connectivity unit 1550 enables wireless connectivity to one or more external devices. The connectivity unit 1550 comprises at least one transmitter and at least one receiver that may be integrated to the apparatus 1500 or that the apparatus 1500 may be connected to. The at least one transmitter comprises at least one transmission antenna, and the at least one receiver comprises at least one receiving antenna. The connectivity unit 1550 may comprise an integrated circuit or a set of integrated circuits that provide the wireless communication capability for the apparatus 1500. Alternatively, the wireless connectivity may be a hardwired application-specific integrated circuit (ASIC). The connectivity unit 1550 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1500 may further comprise various components not illustrated in FIG. 15. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory (ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1.-26. (canceled)

27. An apparatus comprising at least one processor, and at least one memory including computer program instruction that, when executed by the at least one processor, to cause the apparatus to:
transmit information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments;
transmit indications for controlling usage of the radio resources comprised in the plurality of first segments and the at least one second segment at one or more other apparatuses, wherein the indications indicate the following: whether other transmissions are permitted to collide with the plurality of first segments, that no collisions with the at least one second segment are permitted, whether at least a subset of the radio resources comprised in the plurality of first segments are punctured, whether at least a subset of the one or more radio resources comprised in the at least one second segment are punctured, one or more requirements to be fulfilled for permitting collisions with the plurality of first segments, wherein the one or more requirements comprise at least a range for a signal power related metric to be fulfilled at the one or more other apparatuses;
update the one or more indications in response to detecting a change associated with the plurality of first segments and the at least one second segment, wherein the updated one or more indications indicate cancelling a permission for collisions with the plurality of first segments in response to detecting an increased amount of collisions with the plurality of first segments;
transmit the updated one or more indications;
transmit the plurality of first segments and the at least one second segment; and
receive feedback information indicating the following: a presence of one or more collisions associated with the plurality of first segments, a number or proportion of colliding radio resources associated with at least one segment of the plurality of first segments, and a success or failure of combining the plurality of first segments over the at least one second segment;
modify a segment of the plurality of first segments based on the following: one or more past collisions with the segment, and an expected future collision with the segment; and
schedule the sidelink transmission for avoiding collision with one or more other transmissions by dividing the sidelink transmission into the plurality of first segments in the plurality of time slots, wherein the plurality of first segments are scheduled based on the following: a minimum number of first segments, a maximum number of first segments, a minimum number of radio resources per first segment, and a maximum number of radio resources per first segment, and wherein the at least one second segment is scheduled based on the following: a minimum number of second segments, a maximum number of second segments, a minimum length per second segment in time domain, a maximum length per second segment in time domain, a minimum width per second segment in frequency domain, and a maximum width per second segment in frequency domain.

28. The apparatus according to claim 27, wherein the information is based at least partly on a pre-defined resource pattern indicating an allocation of the radio resources in time and frequency domain for the plurality of first segments and for the at least one second segment.

29. The apparatus according to claim 28, wherein the computer program instructions, when executed by the at least on processor, further cause the apparatus to:
receive a request for adding additional radio resources and an additional segment to the at least one second segment; and
add the additional radio resources and the additional segment to the at least one second segment based on the request.

30. The apparatus according to claim 29, wherein the minimum and maximum width is relative to a separation of the plurality of first segments in time domain.

31. The apparatus according to claim 30, wherein the computer program instructions, when executed by the at least on processor, further cause the apparatus to:
transmit an indication indicating one or more time slots of the plurality of time slots comprising the plurality of first segments.

32. The apparatus according to claim 31, wherein the indication is part of the sidelink transmission.

33. The apparatus according to claim 32, wherein the sidelink transmission comprises a sidelink positioning reference signal.

34. A system comprising:
an apparatus;
at least one processor; and
at least one memory including computer program instruction that, when executed by the at least one processor, to cause the apparatus to:
transmit information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments;
transmit indications for controlling usage of the radio resources comprised in the plurality of first segments and the at least one second segment at one or more other apparatuses, wherein the indications indicate the following: whether other transmissions are permitted to collide with the plurality of first segments, that no collisions with the at least one second segment are permitted, whether at least a subset of the radio resources comprised in the plurality of first segments are punctured, whether at least a subset of the one or more radio resources comprised in the at least one second segment are punctured, one or more requirements to be fulfilled for permitting collisions with the plurality of first segments, wherein the one or more requirements comprise at least a range for a signal power related metric to be fulfilled at the one or more other apparatuses;
update the one or more indications in response to detecting a change associated with the plurality of first segments and the at least one second segment, wherein the updated one or more indications indicate cancelling a permission for collisions with the plurality of first segments in response to detecting an increased amount of collisions with the plurality of first segments;
transmit the updated one or more indications;
transmit the plurality of first segments and the at least one second segment; and
receive feedback information indicating the following: a presence of one or more collisions associated with the plurality of first segments, a number or proportion of colliding radio resources associated with at least one segment of the plurality of first segments, and a success or failure of combining the plurality of first segments over the at least one second segment;
modify a segment of the plurality of first segments based on the following: one or more past collisions with the segment, and an expected future collision with the segment; and
schedule the sidelink transmission for avoiding collision with one or more other transmissions by dividing the sidelink transmission into the plurality of first segments in the plurality of time slots, wherein the plurality of first segments are scheduled based on the following: a minimum number of first segments, a maximum number of first segments, a minimum number of radio resources per first segment, and a maximum number of radio resources per first segment, and wherein the at least one second segment is scheduled based on the following: a minimum number of second segments, a maximum number of second segments, a minimum length per second segment in time domain, a maximum length per second segment in time domain, a minimum width per second segment in frequency domain, and a maximum width per second segment in frequency domain.

35. The system according to claim 34, wherein the information is based at least partly on a pre-defined resource pattern indicating an allocation of the radio resources in time and frequency domain for the plurality of first segments and for the at least one second segment.

36. The system according to claim 35, wherein the computer program instructions, when executed by the at least on processor, further cause the apparatus to:
receive a request for adding additional radio resources and an additional segment to the at least one second segment; and
add the additional radio resources and the additional segment to the at least one second segment based on the request.

37. The system according to claim 36, wherein the minimum and maximum width is relative to a separation of the plurality of first segments in time domain.

38. The system according to claim 37, wherein the computer program instructions, when executed by the at least on processor, further cause the apparatus to:
transmit an indication indicating one or more time slots of the plurality of time slots comprising the plurality of first segments.

39. The system according to claim 38, wherein the indication is part of the sidelink transmission.

40. The system according to claim 39, wherein the sidelink transmission comprises a sidelink positioning reference signal.

41. A method comprising:
transmitting information indicating radio resources of a sidelink transmission divided into a plurality of first segments in a plurality of time slots, wherein the plurality of first segments partially overlap in frequency domain, wherein the plurality of first segments are inter-connected in time domain by at least one second segment comprising one or more radio resources for combining the plurality of first segments;
transmitting indications for controlling usage of the radio resources comprised in the plurality of first segments and the at least one second segment at one or more other apparatuses, wherein the indications indicate the following: whether other transmissions are permitted to collide with the plurality of first segments, that no collisions with the at least one second segment are permitted, whether at least a subset of the radio resources comprised in the plurality of first segments are punctured, whether at least a subset of the one or more radio resources comprised in the at least one second segment are punctured, one or more requirements to be fulfilled for permitting collisions with the plurality of first segments, wherein the one or more requirements comprise at least a range for a signal power related metric to be fulfilled at the one or more other apparatuses;
updating the one or more indications in response to detecting a change associated with the plurality of first segments and the at least one second segment, wherein the updated one or more indications indicate cancelling a permission for collisions with the plurality of first segments in response to detecting an increased amount of collisions with the plurality of first segments;
transmitting the updated one or more indications;
transmitting the plurality of first segments and the at least one second segment; and
receiving feedback information indicating the following: a presence of one or more collisions associated with the plurality of first segments, a number or proportion of colliding radio resources associated with at least one segment of the plurality of first segments, and a success or failure of combining the plurality of first segments over the at least one second segment;
modifying a segment of the plurality of first segments based on the following: one or more past collisions with the segment, and an expected future collision with the segment; and
scheduling the sidelink transmission for avoiding collision with one or more other transmissions by dividing the sidelink transmission into the plurality of first segments in the plurality of time slots, wherein the plurality of first segments are scheduled based on the following: a minimum number of first segments, a maximum number of first segments, a minimum number of radio resources per first segment, and a maximum number of radio resources per first segment, and wherein the at least one second segment is scheduled based on the following: a minimum number of second segments, a maximum number of second segments, a minimum length per second segment in time domain, a maximum length per second segment in time domain, a minimum width per second segment in frequency domain, and a maximum width per second segment in frequency domain.

42. The method according to claim 41, wherein the information is based at least partly on a pre-defined resource pattern indicating an allocation of the radio resources in time and frequency domain for the plurality of first segments and for the at least one second segment.

43. The method according to claim 42, further comprising:
receiving a request for adding additional radio resources and an additional segment to the at least one second segment; and
adding the additional radio resources and the additional segment to the at least one second segment based on the request.

44. The method according to claim 43, wherein the minimum and maximum width is relative to a separation of the plurality of first segments in time domain.

45. The method according to claim 37, further comprising transmitting an indication indicating one or more time slots of the plurality of time slots comprising the plurality of first segments.

46. The method according to claim 45, wherein the indication is part of the sidelink transmission, and wherein the sidelink transmission comprises a sidelink positioning reference signal.
